(19) United States
(12) Patent Application Publication
(10) Pub. No.: US 2026/0147191 A1
(43) Pub. Date: May 28, 2026

(54) OPTICAL IMAGING SYSTEM

(71) Applicant: Samsung Electro-Mechanics Co., Ltd., Suwon-si (KR)

(72) Inventors: Phil Ho JUNG, Suwon-si (KR); Dong Hyuk JANG, Suwon-si (KR); Kum Ho KIM, Suwon-si (KR)

(73) Assignee: Samsung Electro-Mechanics Co., Ltd., Suwon-si (KR)

(21) Appl. No.: 19/331,519

(22) Filed: Sep. 17, 2025

(30) Foreign Application Priority Data
Nov. 28, 2024 (KR) 10-2024-0173967

(51) Int. Cl. G02B 13/00

(52) U.S. Cl. CPC G02B 13/0065; G02B 13/0045

(57) ABSTRACT

An optical imaging system includes a plurality of lenses sequentially disposed along an optical axis of the optical imaging system from an object side of the plurality of lenses toward an imaging plane of the optical imaging system; and a reflective member disposed in front of the plurality of lenses and including a reflective surface, wherein the plurality of lenses includes a first lens disposed closest to the reflective member and having a positive refractive power, and a second lens disposed adjacent to the first lens on an image side of the first lens and having a negative refractive power, and conditional expressions 60°<FOV<90° and 1.3<Fno<1.7 are satisfied, where FOV is a field of view of the optical imaging system, and Fno is an F-number of the optical imaging system.

### CROSS-REFERENCE TO RELATED APPLICATIONS

This application claims the benefit under 35 USC 119(a) of Korean Patent Application No. 10-2024-0173967 filed on Nov. 28, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

Recently, a portable terminal includes a camera including an optical imaging system including a plurality of lenses that can make video calls and capture images.

In addition, as the functions performed by a camera in a portable terminal gradually increase, the demand for a camera for a portable terminal having a high resolution is increasing.

In particular, recently, an image sensor having a high number of pixels (e.g., 13 million to 100 million pixels) is being adopted in a camera for a portable terminal to achieve a clearer image quality.

That is, as a size of the image sensor is gradually being increased, a total track length of the optical imaging system also increases, which ultimately leads to the problem of the camera protruding from the portable terminal.

Since the portable terminal is gradually being miniaturized and the camera for the portable terminal needs to be slimmed, the development of an optical imaging system for implementing a high resolution while being slim is needed.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a plurality of lenses sequentially disposed along an optical axis of the optical imaging system from an object side of the plurality of lenses toward an imaging plane of the optical imaging system; and a reflective member disposed in front of the plurality of lenses and including a reflective surface, wherein the plurality of lenses may include a first lens disposed closest to the reflective member and having a positive refractive power, and a second lens disposed adjacent to the first lens on an image side of the first lens and having a negative refractive power, and conditional expressions 60°<FOV<90° and 1.3<Fno<1.7 are satisfied, where FOV is a field of view of the optical imaging system, and Fno is an F-number of the optical imaging system.

The plurality of lenses may include at least two lenses having an Abbe number less than 25 and a negative refractive power.

A conditional expression 1.00<TTL/f<1.29 may be satisfied, where TTL is a distance along the optical axis from an object-side surface of the first lens to the imaging plane, and f is a total focal length of the optical imaging system.

Conditional expressions 0.5<f1/f<1.5 and −3.5<f2/f<−1 may be satisfied, where f1 is a focal length of the first lens, f2 is a focal length of the second lens, and f is a total focal length of the optical imaging system.

A conditional expression 1.2<f12/f<1.6 may be satisfied, where f12 is a composite focal length of the first lens and the second lens, and f is a total focal length of the optical imaging system.

A conditional expression 1.0<f123/f<1.9 may be satisfied, where f123 is a composite focal length of the first lens, the second lens, and the third lens, and f is a total focal length of the optical imaging system.

A conditional expression 0<|f1/f2|<0.6 may be satisfied, where f1 is a focal length of the first lens, and f2 is a focal length of the second lens.

A conditional expression 0.05 mm/°<TTL/FOV<0.2 mm/° may be satisfied, where TTL is a distance along the optical axis from an object-side surface of the first lens to the imaging plane.

Conditional expressions 15<v2<25 and 30<v1−v2<60 may be satisfied, where v1 is an Abbe number of the first lens, and v2 is an Abbe number of the second lens.

The plurality of lenses may further include a third lens disposed adjacent to the second lens on an image side of the second lens, and a conditional expression 0<|v1−(v2+v3)|<19 may be satisfied, where v1 is an Abbe number of the first lens, v2 is an Abbe number of the second lens, and v3 is an Abbe number of the third lens.

A conditional expression −1.0<(R1-R2)/(R1+R2)<−0.3 may be satisfied, where R1 is a radius of curvature of an object-side surface of the first lens, and R2 is a radius of curvature of an image-side surface of the first lens.

The plurality of lenses may further include a third lens, a fourth lens, a fifth lens, a sixth lens, and a seventh lens, and the first lens, the second lens, the third lens, the fourth lens, the fifth lens, the sixth lens, and the seventh lens may be sequentially disposed in ascending numerical order along the optical axis from an object side of the first lens toward the imaging plane.

The first lens may have a positive refractive power, the second lens may have a negative refractive power, the third lens may have a negative refractive power, the fourth lens may have a positive refractive power, the fifth lens may have a negative refractive power, the sixth lens may have a positive refractive power, and the seventh lens may have a negative refractive power.

Any one or any combination of any two or more of conditional expressions 4<|f3/f|<17, 1.5<|f4/f|<3.5, and 2<|f5/f|<31 may be satisfied, where f3 is a focal length of the third lens, f4 is a focal length of the fourth lens, f5 is a focal length of the fifth lens, and f is a total focal length of the optical imaging system.

A conditional expression 0<|f1/f3|<0.4 may be satisfied, where f1 is a focal length of the first lens, and f3 is a focal length of the third lens.

A conditional expression 0<|f2/f3|<0.7 may be satisfied, where f2 is a focal length of the second lens, and f3 is a focal length of the third lens.

The plurality of lenses may further include a third lens, a fourth lens, a fifth lens, a sixth lens, a seventh lens, and an eighth lens, and the first lens, the second lens, the third lens, the fourth lens, the fifth lens, the sixth lens, the seventh lens, and the eighth lens may be sequentially disposed in ascending numerical order along the optical axis from an object side of the first lens toward the imaging plane.

The first lens may have a positive refractive power, the second lens may have a negative refractive power, the third lens may have a positive refractive power, the seventh lens may have a positive refractive power, and the eighth lens may have a negative refractive power.

The optical imaging system may further include a stop disposed between an object-side surface of the first lens and the reflective member.

A rearmost lens of the plurality of lenses may have a major axis and a minor axis perpendicular to each other and intersecting each other and intersecting the optical axis, and the major axis may be longer than the minor axis.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a diagram illustrating aberration characteristics of the optical imaging system illustrated in FIG. 1.

FIG. 3 is a configuration diagram of an optical imaging system according to a second embodiment of the present disclosure.

FIG. 4 is a diagram illustrating aberration characteristics of the optical imaging system illustrated in FIG. 3.

FIG. 5 is a configuration diagram of an optical imaging system according to a third embodiment of the present disclosure.

FIG. 6 is a diagram illustrating aberration characteristics of the optical imaging system illustrated in FIG. 5.

FIG. 7 is a configuration diagram of an optical imaging system according to a fourth embodiment of the present disclosure.

FIG. 8 is a diagram illustrating aberration characteristics of the optical imaging system illustrated in FIG. 7.

FIG. 9 is a schematic perspective view of an optical imaging system according to an embodiment of the present disclosure.

FIG. 10 is a plan view of a non-circular lens included in the optical imaging system of FIG. 10.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the configuration diagrams in the drawings, the thickness, size, and shape of the lenses may be somewhat exaggerated for clarity of explanation, and in particular, the aspherical shape of the lenses in the configuration diagrams is only an example, and is not limited thereto.

An optical imaging system according to an embodiment of the present disclosure may be mounted on a portable electronic device. For example, the optical imaging system may be a component of a camera module mounted on a portable electronic device. A portable electronic device may be a portable electronic device such as a mobile communication terminal, a smartphone, a tablet PC, or any other portable electronic device.

In the present specification, all numerical values of a radius of curvature, a thickness, a distance, a focal length, and other dimensions are expressed in millimeters, and a field of view (FOV) is expressed in degrees.

In addition, in a description of a shape of a lens, a statement that a surface of a lens is convex means that a paraxial region of the surface is convex, and a statement that a surface of a lens is concave means that a paraxial region of the surface is concave.

Accordingly, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging plane may refer to an imaginary plane on which a focus is formed by an optical imaging system. Alternatively, the imaging plane may refer to a surface of an image sensor on which light is received through the optical imaging system.

An optical imaging system according to an embodiment of the present disclosure includes a plurality of lenses. For example, the optical imaging system may include seven or eight lenses.

In an embodiment, the optical imaging system may include a first lens, a second lens, a third lens, a fourth lens, a fifth lens, a sixth lens, a seventh lens, and an eighth lens sequentially disposed in ascending numerical order along an optical axis of the optical imaging system from an object side of the first lens toward an imaging plane of the optical imaging system.

In another embodiment, the optical imaging system may include a first lens, a second lens, a third lens, a fourth lens, a fifth lens, a sixth lens, and a seventh lens sequentially disposed in ascending numerical order along an optical axis of the optical imaging system from an object side of the first lens toward an imaging plane of the optical imaging system.

A lens disposed closest to an object side of the optical imaging system (a frontmost lens) is a first lens, and a lens disposed closest to an imaging plane (or image sensor) (a rearmost lens) is a seventh or eighth lens.

The plurality of lenses included in the optical imaging system may be spaced apart from each other by predetermined distances along the optical axis of the optical imaging system.

The optical imaging system according to an embodiment of the present disclosure may further include an image sensor for converting an image of a subject incident onto the image sensor into an electric signal.

In addition, the optical imaging system may further include an infrared cut-off filter (hereinafter, referred to simply as a filter) for blocking infrared rays. The filter may be disposed between the rearmost lens and the image sensor.

In addition, the optical imaging system may further include a stop for controlling an amount of light passing through the optical imaging system. The stop may be disposed in front of the first lens.

The optical imaging system according to an embodiment of the present disclosure may further include a reflective member having a reflective surface for changing a direction of light passing through the optical imaging system. For example, the reflective member may be a mirror or a prism. In an embodiment, the reflective member may be disposed in front of the first lens.

When the reflective member is a prism, the reflective member may have any one of the shapes obtained by dividing a rectangular solid (or a cube) into two halves in a diagonal direction. The reflective member may include an incident surface, a reflective surface, and an emission surface. The reflective member has three rectangular surfaces and two triangular surfaces. For example, each of the incident surface, the reflective surface, and the emission surface of the reflective member is rectangular, and both side surfaces of the reflective member are roughly triangular.

Light may be incident on the incident surface of the reflective member, the light incident on the incident surface may be reflected from the reflective surface, and the light reflected from the reflective surface may be emitted from the emission surface. The light emitted from the emission surface may be incident on the first lens.

Since a portable electronic device in which an optical imaging system is disposed has a relatively small size, it is difficult to apply an image sensor having a high number pixels. That is, as the number of pixels in the image sensor increases, the size of the image sensor also increases, but it is difficult to install an image sensor having a high number of pixels in the limited installation space in a portable electronic device.

However, by bending light using a reflective member, the optical imaging system according to an embodiment of the present disclosure may increase a degree of freedom in a dispositional form of the image sensor in a portable electronic device, enabling an image sensor having a high number of pixels to be applied.

Since the optical imaging system according to an embodiment of the present disclosure changes a direction of propagation of light using a reflective member, an optical axis of the optical imaging system may be formed in both a width direction and a length direction of the portable electronic device. In this case, a diameter of the plurality of lenses of the optical imaging system may be a factor affecting a thickness of the portable electronic device.

Therefore, the optical imaging system according to an embodiment of the present disclosure may prevent an increase in the thickness of the portable electronic device by forming at least one lens of the plurality of lenses in a non-circular shape. In an embodiment, a lens having a non-circular planar shape may be a lens having a relatively large diameter among the plurality of lenses.

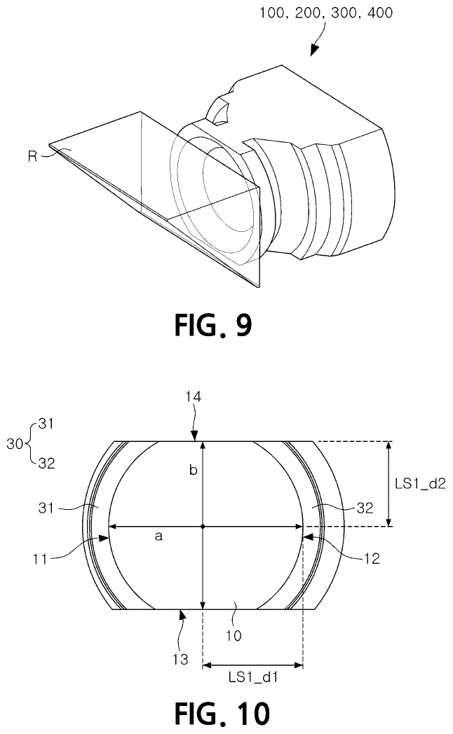

FIG. 9 is a schematic perspective view of an optical imaging system according to an embodiment of the present disclosure, and FIG. 10 is a plan view of a non-circular lens included in the optical imaging system of FIG. 10.

Referring to FIGS. 9 and 10, at least a portion of the lenses of an optical imaging system 100, 200, 300, or 400 according to first to fourth embodiments of the present disclosure described below have a non-circular planar shape. For example, the rearmost lens of the optical imaging system may have a non-circular planar shape.

A non-circular lens has two axes intersecting each other and intersecting an optical axis of the non-circular lens. The two axes and the optical axis are perpendicular to each other. One of the two axes is longer than the other one of the two axes.

All of the lenses of the optical imaging system include an optical portion 10 and a flange portion 30.

The optical portion 10 may be a portion exhibiting an optical characteristic of the lens. For example, light reflected from a subject may pass through the optical portion 10 and be refracted.

The optical portion 10 may have a refractive power, and may have an aspherical shape.

In addition, the optical portion 10 includes an object-side surface (a surface facing an object side of the optical imaging system) and an image-side surface (a surface facing an image side of the optical imaging system). The object-side surface of the optical portion 10 is illustrated in FIG. 10.

The flange portion 30 may be a portion fixing the lens to another element, for example, a lens barrel or another lens.

The flange portion 30 may extend around at least a portion of the optical portion 10, and may be formed integrally with the optical portion 10.

In an embodiment, a non-circular lens may mean that an overall shape of the lens, including the optical portion 10 and the flange portion 30, is non-circular. In this case, the shape of the optical portion 10 itself may also be non-circular.

In another embodiment, the shape of the optical portion 10 itself may be circular, and an overall shape of the lens, including the flange portion 30, may be non-circular.

Referring to FIG. 10, the optical portion 10 may have a non-circular shape.

The optical portion 10 includes a first edge 11, a second edge 12, a third edge 13, and a fourth edge 14, and the first edge 11 and the second edge 12 are positioned to face each other, and the third edge 13 and the fourth edge 14 are positioned to face each other.

The third edge 13 and the fourth edge 14 connect the first edge 11 and the second edge 12 to each other.

The first edge 11 and the second edge 12 are disposed on opposite sides of an optical axis of the lens, and the third edge 13 and the fourth edge 14 are disposed on opposite sides of the an optical axis.

When viewed in a direction of the optical axis, the first edge 11 and the second edge 12 have an arc shape, and the third edge 13 and the fourth edge 14 have a generally straight shape. The third edge 13 and the fourth edge 14 may be symmetrical with respect to the optical axis, and may be parallel to each other.

A shortest distance between the first edge 11 and the second edge 12 is longer than a shortest distance between the third edge 13 and the fourth edge 14.

The optical portion 10 has a major axis (a) and a minor axis (b). For example, when viewed in the direction of the optical axis, a shortest line segment connecting the third edge 13 and the fourth edge 14 to each other while passing through the optical axis is the minor axis (b), and a line segment connecting the first edge 11 and the second edge 12 to each other while passing through the optical axis and being perpendicular to the minor axis (b) is the major axis (a).

One half of the major axis (a) is a maximum effective radius of the non-circular lens, and one half of the minor axis (b) is a minimum effective radius of the non-circular lens.

In the case that the lens illustrated in FIG. 10 is a rearmost lens (e.g., a seventh lens or an eighth lens), a maximum effective radius LS1_d1 of an object-side surface of the rearmost lens is larger than a minimum effective radius LS1_d2 of the object-side surface of the rearmost lens.

In addition, a ratio of the minimum effective radius LS1_d2 to the maximum effective radius LS1_d1 may be greater than 0.5 and less than 1, i.e., 0.5<LS1_d2/LS1_d1<1.

An effective radius of a lens surface is a radius of a portion of the lens surface through which light actually passes. That is, the effective radius is a radius of the optical portion 10 of each lens. An object-side surface of a lens and an image-side surface of the lens may have different effective radiuses.

In this specification, an effective radius refers to a maximum effective radius of a lens surface unless otherwise specified.

The flange portion 30 includes a first flange portion 31 and a second flange portion 32. The first flange portion 31 extends from the first edge 11 of the optical portion 10, and the second flange portion 32 extends from the second edge 12 of the optical portion 10.

The first edge 11 of the optical portion 10 is an edge of the optical portion 10 adjacent to the first flange portion 31, and the second edge 12 of the optical portion 10 is an edge of the optical portion 10 adjacent to the second flange portion 32.

The third edge 13 of the optical portion 10 is an edge of the optical portion 10 where the flange portion 30 is not formed on one side of the optical axis, and the fourth edge 14 of the optical portion 10 an edge of the optical portion 10 where the flange portion 30 is not formed on an opposite side of the optical axis.

Each of the plurality of lenses constituting the optical imaging system according to an embodiment of the present disclosure may be made of a plastic material.

In addition, at least one of the plurality of lenses has an aspherical surface. For example, each of the plurality of lenses may have at least one aspherical surface.

That is, either one or both of an object-side surface and an image-side surface of each lens may be aspherical. The aspherical surfaces of the lenses are defined by the Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy any one or any combination of any two or more of the following conditional expressions.

$$60 ° < FOV < 90 ° \qquad ( Conditional Expression 1 )$$

$$1.3 < Fno < 1.7 \qquad ( Conditional Expression 2 )$$

$$0.5 < f 1 / f < 1.5 \qquad ( Conditional Expression 3 )$$

$$15 < v 2 < 25 \qquad ( Conditional Expression 4 )$$

$$0.05 mm / ° < TTL / FOV < 0.2 mm / ° \qquad ( Conditional Expression 5 )$$

$$1. < TTL / f < 1.29 \qquad ( Conditional Expression 6 )$$

$$30 < v 1 - v 2 < 60 \qquad ( Conditional Expression 7 )$$

$$0 < \vert v 1 - ( v 2 + v 3 ) \vert < 19 \qquad ( Conditional Expression 8 )$$

$$- 1. < ( R 1 - R 2 ) / ( R 1 + R 2 ) < - 0.3 \qquad ( Conditional Expression 9 )$$

$$- 3.5 < f 2 / f < - 1 \qquad ( Conditional Expression 10 )$$

$$4 < \vert f 3 / f \vert < 17 \qquad ( Conditional Expression 11 )$$

$$1.5 < \vert f 4 / f \vert < 3.5 \qquad ( Conditional Expression 12 )$$

$$2 < \vert f 5 / f \vert < 31 \qquad ( Conditional Expression 13 )$$

$$0 < \vert f 1 / f 2 \vert < 0.6 \qquad ( Conditional Expression 14 )$$

$$0 < \vert f 1 / f 3 \vert < 0.4 \qquad ( Conditional Expression 15 )$$

$$0 < \vert f 2 / f 3 \vert < 0.7 \qquad ( Conditional Expression 16 )$$

$$1.2 < f 12 / f < 1.6 \qquad ( Conditional Expression 17 )$$

$$1. < f 123 f < 1.9 \qquad ( Conditional Expression 18 )$$

In an embodiment, the optical imaging system may satisfy 60°<FOV<90° (Conditional Expression 1), where FOV is a field of view of the optical imaging system. The optical imaging system according to an embodiment of the present disclosure may be a wide-angle optical imaging system.

In an embodiment, the optical imaging system may satisfy 1.3<Fno<1.7 (Conditional Expression 2), where Fno is an F-number of the optical imaging system. Therefore, a clear image may be captured even in a dark place.

In an embodiment, the optical imaging system may satisfy 0.5<f1/f<1.5 (Conditional Expression 3), where f1 is a focal length of the first lens, and f is a total focal length of the optical imaging system. Therefore, the occurrence of aberration may be minimized by appropriately adjusting the refractive power of the first lens.

In an embodiment, the optical imaging system may satisfy 15<v2<25 (Conditional Expression 4), where v2 is an Abbe number of the second lens. Therefore, chromatic aberration may be improved.

In an embodiment, the optical imaging system may satisfy 0.05 mm/°<TTL/FOV<0.2 mm/° (Conditional Expression 5), where TTL is a distance along an optical axis of the optical imaging system from an object-side surface of the first lens to an imaging plane of the optical imaging system. Accordingly, the optical imaging system may have an appropriate field of view and total track length.

In an embodiment, the optical imaging system may satisfy 1.00<TTL/f<1.29 (Conditional Expression 6). Accordingly, the optical imaging system may have an appropriate field of view and total track length.

In an embodiment, the optical imaging system may satisfy 30<v1−v2<60 (Conditional Expression 7), where v1 is an Abbe number of the first lens, and v2 is an Abbe number of the second lens. Therefore, chromatic aberration may be improved.

In an embodiment, the optical imaging system may satisfy 0<|v1−(v2+v3)|<19 (Conditional Expression 8), where v3 is an Abbe number of the third lens. Therefore, chromatic aberration may be improved.

In an embodiment, the optical imaging system may satisfy −1.0<(R1−R2)/(R1+R2)<−0.3 (Conditional Expression 9), where R1 is a radius of curvature of the object-side surface of the first lens, and R2 is a radius of curvature of an image-side surface of the first lens. Therefore, spherical aberration occurring in a first lens group may be minimized.

In an embodiment, the optical imaging system may satisfy −3.5<f2/f<−1 (Conditional Expression 10), where f2 is a focal length of the second lens. Accordingly, the occurrence of aberration may be minimized by appropriately adjusting the refractive power of the second lens.

In an embodiment, the optical imaging system may satisfy 4<|f3/f|<17 (Conditional Expression 11), where f3 is a focal length of the third lens. Accordingly, the occurrence of aberration may be minimized by appropriately adjusting the refractive power of the third lens.

In an embodiment, the optical imaging system may satisfy 1.5<|f4/f|<3.5 (Conditional Expression 12), where f4 is a focal length of the fourth lens. Accordingly, the occurrence of aberration may be minimized by appropriately adjusting the refractive power of the fourth lens.

In an embodiment, the optical imaging system may satisfy 2<|f5/f|<31 (Conditional Expression 13), where f5 is a focal length of the fifth lens. Accordingly, the occurrence of aberration may be minimized by appropriately adjusting the refractive power of the fifth lens.

In an embodiment, the optical imaging system may satisfy 0<|f1/f2|<0.6 (Conditional Expression 14). Accordingly, the resolution may be improved by appropriately adjusting the refractive power of the first lens and the second lens.

In an embodiment, the optical imaging system may satisfy 0<|f1/f3|<0.4 (Conditional Expression 15). Accordingly, the resolution may be improved by appropriately adjusting the refractive power of the first lens and the third lens.

In an embodiment, the optical imaging system may satisfy 0<|f2/f3|<0.7 (Conditional Expression 16). Accordingly, the resolution may be improved by appropriately adjusting the refractive power of the second lens and the third lens.

In an embodiment, the optical imaging system may satisfy 1.2<f12/f<1.6 (Conditional Expression 17), where f12 is a composite focal length of the first lens and the second lens. Therefore, the resolution may be improved by appropriately adjusting the refractive power of the first lens and the second lens.

In an embodiment, the optical imaging system may satisfy 1.0<f123/f<1.9 (Conditional Expression 18), where f123 is a composite focal length of the first lens, the second lens, and the third lens. Therefore, the resolution may be improved by appropriately adjusting the refractive power of the first to third lenses.

The first lens has a positive refractive power. In addition, the first lens may have a meniscus shape convex toward an object side. For example, an object-side surface of the first lens may be convex in a paraxial region thereof, and an image-side surface of the first lens may be concave in a paraxial region thereof.

The second lens has a negative refractive power. In addition, the second lens may have a meniscus shape convex toward an object side. For example, an object-side surface of the second lens may be convex in a paraxial region thereof, and an image-side surface of the second lens may be concave in a paraxial region thereof.

The third lens has a positive refractive power or a negative refractive power. In addition, the third lens may have a meniscus shape convex toward an object side. For example, an object-side surface of the third lens may be convex in a paraxial region thereof, and an image-side surface of the third lens may be concave in a paraxial region thereof.

The fourth lens has a positive refractive power or a negative refractive power. In addition, the fourth lens may have a meniscus shape convex toward an image side. For example, an object-side surface of the fourth lens may be concave in a paraxial region thereof, and an image-side surface of the fourth lens may be convex in a paraxial region thereof. Alternatively, both surfaces of the fourth lens may be concave in respective paraxial regions thereof. For example, an object-side surface and an image-side surface of the fourth lens may be concave in respective paraxial regions thereof. Alternatively, both surfaces of the fourth lens may be convex in respective paraxial regions thereof. For example, an object-side surface and an image-side surface of the fourth lens may be convex in respective paraxial regions thereof.

The fifth lens has a positive refractive power or a negative refractive power. In addition, both surfaces of the fifth lens may be concave in respective paraxial regions thereof. For example, an object-side surface and an image-side surface of the fifth lens may be concave in respective paraxial regions thereof. Alternatively, the fifth lens may have a meniscus shape convex toward an image side. For example, an object-side surface of the fifth lens may be concave in a paraxial region thereof, and an image-side surface of the fifth lens may be convex in a paraxial region thereof. Alternatively, the fifth lens may have a meniscus shape convex toward an object side. For example, an object-side surface of the fifth lens may be convex in a paraxial region thereof, and an image-side surface of the fifth lens may be concave in a paraxial region thereof.

The sixth lens has a positive refractive power or a negative refractive power. In addition, the sixth lens may have a meniscus shape convex toward an object side. For example, an object-side surface of the sixth lens may be convex in a paraxial region thereof, and an image-side surface of the sixth lens may be concave in a paraxial region thereof.

The seventh lens has a positive refractive power or a negative refractive power. In addition, both surfaces of the seventh lens may be concave in respective paraxial regions thereof. For example, an object-side surface and an image-side surface of the seventh lens may be concave in respective paraxial regions thereof. Alternatively, the seventh lens may have a meniscus shape convex toward an object side. For example, an object-side surface of the seventh lens may be convex in a paraxial region thereof, and an image-side surface of the seventh lens may be concave in a paraxial region thereof. Alternatively, both surfaces of the seventh lens may be convex in respective paraxial regions thereof. For example, an object-side surface and an image-side surface of the seventh lens may be convex in respective paraxial regions thereof.

The eighth lens has a negative refractive power. In addition, the eighth lens may have a meniscus shape convex toward an object side. For example, an object-side surface of the eighth lens may be convex in a paraxial region thereof, and an image-side surface of the eighth lens may be concave in a paraxial region thereof. Alternatively, both surfaces of the eighth lens may be concave in paraxial regions thereof. For example, an object-side surface and an image-side surface of the eighth lens may be concave in respective paraxial regions thereof.

Among the plurality of lenses of the optical imaging system, a lens disposed closest to an imaging plane may have at least one inflection point formed on either one or both of the object-side surface and the image-side surface thereof.

Among the plurality of lenses of the optical imaging system, a lens disposed second closest to an imaging plane may have at least one inflection point formed on either one or both of the object-side surface and the image-side surface thereof.

Among the plurality of lenses of the optical imaging system, at least two lenses may have a refractive index of 1.63 or more. For example, the refractive index of at least two lenses among the first to fifth lenses may be 1.63 or more and less than 1.7.

In an embodiment, the second lens and the fifth lens may have a refractive index of 1.67 or more.

In an embodiment, the second lens and the fourth lens may have a refractive index of 1.63 or more.

In an embodiment, the second lens and the third lens may have a refractive index of 1.67 or more.

Each of the plurality of lenses of the optical imaging system may have a predetermined Abbe number. At least two lenses among the plurality of lenses may have an Abbe number less than 25. All lenses having an Abbe number less than 25 may have a negative refractive power.

In an embodiment, the number of lenses having an Abbe number less than 25 may be two.

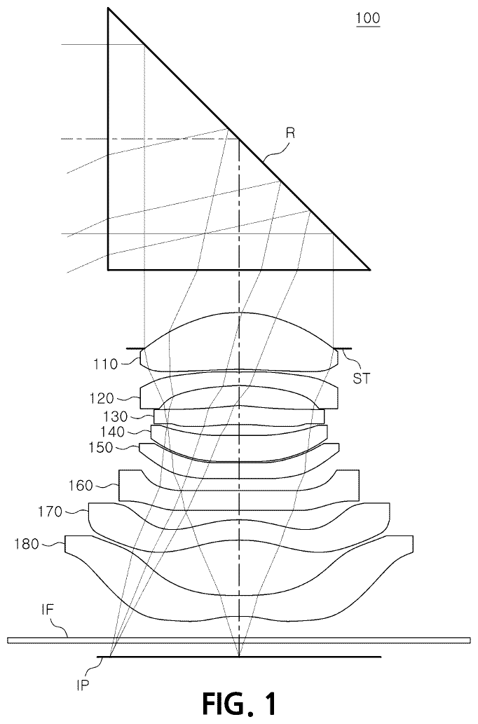

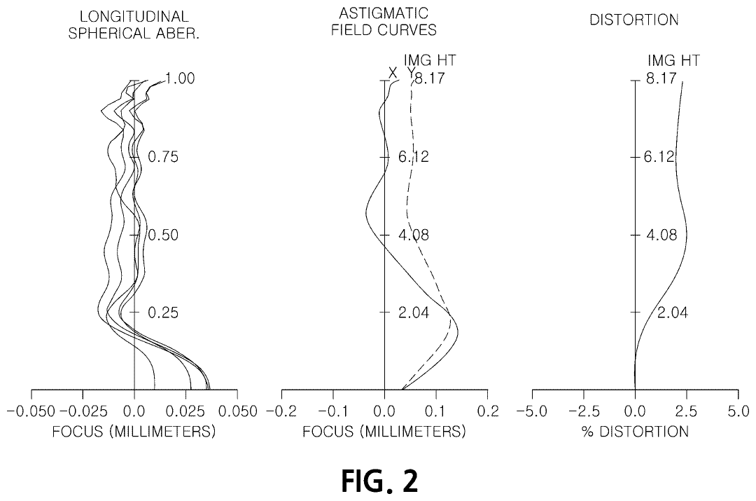

FIG. 1 is a configuration diagram of an optical imaging system according to a first embodiment of the present disclosure, and FIG. 2 is a diagram illustrating aberration characteristics of the optical imaging system illustrated in FIG. 1.

Referring to FIG. 1, an optical imaging system 100 according to a first embodiment of the present disclosure includes a first lens 110, a second lens 120, a third lens 130, a fourth lens 140, a fifth lens 150, a sixth lens 160, a seventh lens 170, and an eighth lens 180 sequentially disposed in ascending numerical order along an optical axis of the optical imaging system 100 from an object side of the first lens 110 toward an imaging plane IP, and may further include a filter IF and an image sensor (not shown).

The optical imaging system 100 may further include a reflective member R disposed in front of the first lens 110. The reflective member R may be a prism, but may also be provided as a mirror.

The optical imaging system 100 may further include a stop ST. The stop ST may be disposed in front of an object-side surface of the first lens 110. For example, the stop ST may be disposed at an end of an effective radius of the object-side surface of the first lens 110.

The optical imaging system 100 according to the first embodiment of the present disclosure may form a focus on the imaging plane IP.

Lens characteristics of each lens (radiuses of curvature, a thickness of a lens or a distance between lenses, a refractive index, and an Abbe number) are illustrated in Table 1 below.

TABLE 1

| Surface | | Radius of | Thickness/ | Refractive | Abbe |
|---|---|---|---|---|---|
| No. | Element | Curvature | Distance | Index | Number |
| S1 | First | 4.844 | 2.166 | 1.544 | 56.1 |
| S2 | Lens | 130.870 | 0.050 | | |
| S3 | Second | 19.346 | 0.550 | 1.6867 | 18.4 |
| S4 | Lens | 7.296 | 0.772 | | |
| S5 | Third | 8.996 | 0.716 | 1.544 | 56.1 |
| S6 | Lens | 11.298 | 0.396 | | |
| S7 | Fourth | −33.203 | 1.019 | 1.544 | 56.1 |
| S8 | Lens | −12.349 | 0.050 | | |
| S9 | Fifth | −27.737 | 0.600 | 1.6867 | 18.4 |
| S10 | Lens | 2520.167 | 0.413 | | |
| S11 | Sixth | 26.303 | 0.786 | 1.568 | 37.4 |
| S12 | Lens | 27.465 | 0.337 | | |
| S13 | Seventh | 3.872 | 0.787 | 1.568 | 37.4 |
| S14 | Lens | 5.366 | 2.084 | | |
| S15 | Eighth | 86.573 | 0.830 | 1.5348 | 55.7 |
| S16 | Lens | 5.060 | 0.800 | | |
| S17 | Filter | Infinity | 0.210 | 1.517 | 64.2 |
| S18 | | Infinity | 0.518 | | |
| S19 | Imaging | Infinity | | | |
| | Plane | | | | |

In the first embodiment of the present disclosure, the first lens 110 has a positive refractive power, an object-side surface of the first lens 110 is convex in a paraxial region thereof, and an image-side surface of the first lens 110 is concave in a paraxial region thereof.

The second lens 120 has a negative refractive power, an object-side surface of the second lens 120 is convex in a paraxial region thereof, and an image-side surface of the second lens 120 is concave in a paraxial region thereof.

The third lens 130 has a positive refractive power, an object-side surface of the third lens 130 is convex in a paraxial region thereof, and an image-side surface of the third lens 130 is concave in a paraxial region thereof.

The fourth lens 140 has a positive refractive power, an object-side surface of the fourth lens 140 is concave in a paraxial region thereof, and an image-side surface of the fourth lens 140 is convex in a paraxial region thereof.

The fifth lens 150 has a negative refractive power, and an object-side surface and an image-side surface of the fifth lens 150 are concave in respective paraxial regions thereof.

The sixth lens 160 has a positive refractive power, an object-side surface of the sixth lens 160 is convex in a paraxial region thereof, and an image-side surface of the sixth lens 160 is concave in a paraxial region thereof.

The seventh lens 170 has a positive refractive power, an object-side surface of the seventh lens 170 is convex in a paraxial region thereof, and an image-side surface of the seventh lens 170 is concave in a paraxial region thereof.

The eighth lens 180 has a negative refractive power, an object-side surface of the eighth lens 180 is convex in a paraxial region thereof, and an image-side surface of the eighth lens 180 is concave in a paraxial region thereof.

In addition, either one or both of the seventh lens 170 and the eighth lens 180 has at least one inflection point on either one or both of the object-side surface and the image-side surface thereof.

For example, the object-side surface of the seventh lens 170 may be convex in a paraxial region thereof and concave in a portion other than the paraxial region.

Each surface of each of the first lens 110 to the eighth lens 180 has aspherical surface coefficients as illustrated in Table 2 below. For example, the object-side surface and the image-side surface of each of the first lens 110 to the eighth lens 180 are both aspherical.

TABLE 2

| Surface | | | | | | |
|---|---|---|---|---|---|---|
| No. | S1 | S2 | S3 | S4 | S5 | S6 |
| K | −1.088E+00 | −8.916E+01 | −4.102E+01 | 2.279E+00 | −3.823E+01 | −6.495E+01 |
| A | −6.717E−04 | −2.735E−02 | −2.340E−02 | −3.707E−03 | −4.905E−03 | −3.816E−04 |
| B | 2.349E−04 | 3.245E−02 | 2.845E−02 | 9.760E−03 | 1.009E−02 | 8.133E−04 |
| C | −9.984E−04 | −2.440E−02 | −2.165E−02 | −9.429E−03 | −1.286E−02 | −1.166E−05 |
| D | 1.007E−03 | 1.279E−02 | 1.155E−02 | 6.169E−03 | 1.170E−02 | 1.367E−03 |
| E | −5.585E−04 | −4.797E−03 | −4.439E−03 | −2.879E−03 | −7.117E−03 | −1.763E−03 |
| F | 1.990E−04 | 1.309E−03 | 1.246E−03 | 9.898E−04 | 2.991E−03 | 1.142E−03 |
| G | −4.853E−05 | −2.631E−04 | −2.579E−04 | −2.583E−04 | −8.923E−04 | −4.642E−04 |
| H | 8.345E−06 | 3.907E−05 | 3.946E−05 | 5.218E−05 | 1.916E−04 | 1.273E−04 |
| J | −1.023E−06 | −4.271E−06 | −4.439E−06 | −8.193E−06 | −2.972E−05 | −2.418E−05 |
| L | 8.899E−08 | 3.390E−07 | 3.618E−07 | 9.838E−07 | 3.297E−06 | 3.190E−06 |
| M | −5.367E−09 | −1.898E−08 | −2.074E−08 | −8.683E−08 | −2.549E−07 | −2.869E−07 |
| N | 2.135E−10 | 7.103E−10 | 7.922E−10 | 5.257E−09 | 1.303E−08 | 1.676E−08 |
| O | −5.036E−12 | −1.593E−11 | −1.810E−11 | −1.932E−10 | −3.951E−10 | −5.731E−10 |
| P | 5.337E−14 | 1.619E−13 | 1.873E−13 | 3.223E−12 | 5.376E−12 | 8.690E−12 |

| Surface | | | | | | |
|---|---|---|---|---|---|---|
| No. | S7 | S8 | S9 | S10 | S11 | S12 |
| K | 8.208E+01 | 9.482E+00 | −9.852E+01 | 9.900E+01 | 3.060E+01 | 2.263E+01 |
| A | −3.254E−03 | 3.591E−02 | 4.182E−02 | 2.304E−02 | 1.436E−02 | 2.355E−02 |
| B | 1.170E−02 | −6.653E−02 | −6.274E−02 | −1.891E−02 | −1.188E−02 | −1.576E−02 |
| C | −1.559E−02 | 6.585E−02 | 5.806E−02 | 1.299E−02 | 6.278E−03 | 7.818E−03 |
| D | 1.420E−02 | −4.169E−02 | −3.543E−02 | −6.332E−03 | −2.142E−03 | −2.765E−03 |
| E | −8.708E−03 | 1.856E−02 | 1.542E−02 | 2.241E−03 | 4.623E−04 | 7.030E−04 |
| F | 3.730E−03 | −6.026E−03 | −4.941E−03 | −5.814E−04 | −4.966E−05 | −1.297E−04 |
| G | −1.145E−03 | 1.446E−03 | 1.178E−03 | 1.110E−04 | −2.939E−06 | 1.757E−05 |
| H | 2.544E−04 | −2.573E−04 | −2.092E−04 | −1.560E−05 | 2.078E−06 | −1.751E−06 |
| J | −4.098E−05 | 3.382E−05 | 2.754E−05 | 1.602E−06 | −3.834E−07 | 1.276E−07 |
| L | 4.729E−06 | −3.236E−06 | −2.646E−06 | −1.182E−07 | 4.132E−08 | −6.699E−09 |
| M | −3.804E−07 | 2.191E−07 | 1.800E−07 | 6.074E−09 | −2.851E−09 | 2.456E−10 |
| N | 2.023E−08 | −9.936E−09 | −8.206E−09 | −2.051E−10 | 1.243E−10 | −5.953E−12 |
| O | −6.380E−10 | 2.706E−10 | 2.246E−10 | 4.058E−12 | −3.130E−12 | 8.563E−14 |
| P | 9.026E−12 | −3.343E−12 | −2.787E−12 | −3.526E−14 | 3.475E−14 | −5.529E−16 |

| Surface | | | | |
|---|---|---|---|---|
| No. | S13 | S14 | S15 | S16 |
| K | −1.000E+00 | −1.114E+01 | 9.249E+01 | −1.000E+00 |
| A | 2.280E−02 | −2.908E−03 | 2.320E−02 | 2.410E−02 |
| B | −9.401E−03 | −1.653E−04 | −3.913E−03 | −4.538E−03 |
| C | 3.929E−03 | 4.276E−04 | 6.567E−04 | 8.261E−04 |
| D | −1.140E−03 | −1.088E−04 | −9.370E−05 | −1.224E−04 |
| E | 2.407E−04 | 1.539E−05 | 1.116E−05 | 1.415E−05 |
| F | −3.768E−05 | −1.401E−06 | −1.099E−06 | −1.238E−06 |
| G | 4.400E−06 | 8.326E−08 | 8.904E−08 | 8.084E−08 |
| H | −3.821E−07 | −2.935E−09 | −5.916E−09 | −3.897E−09 |
| J | 2.442E−08 | 2.800E−11 | 3.099E−10 | 1.369E−10 |
| L | −1.128E−09 | 2.791E−12 | −1.204E−11 | −3.429E−12 |
| M | 3.652E−11 | −1.579E−13 | 3.267E−13 | 5.918E−14 |
| N | −7.844E−13 | 3.999E−15 | −5.772E−15 | −6.628E−16 |
| O | 1.001E−14 | −5.235E−17 | 5.936E−17 | 4.288E−18 |
| P | −5.740E−17 | 2.865E−19 | −2.689E−19 | −1.197E−20 |

The optical imaging system 100 according to the first embodiment may have aberration characteristics as illustrated in FIG. 2.

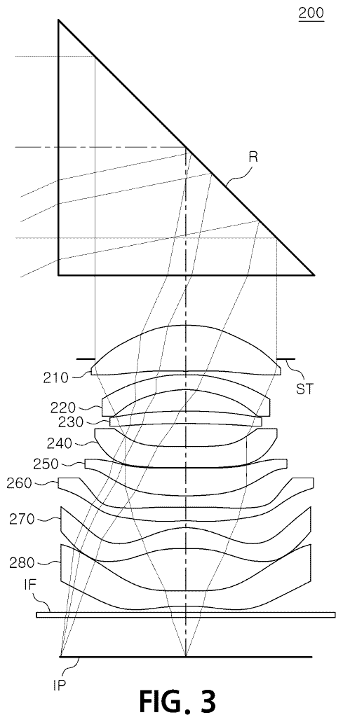

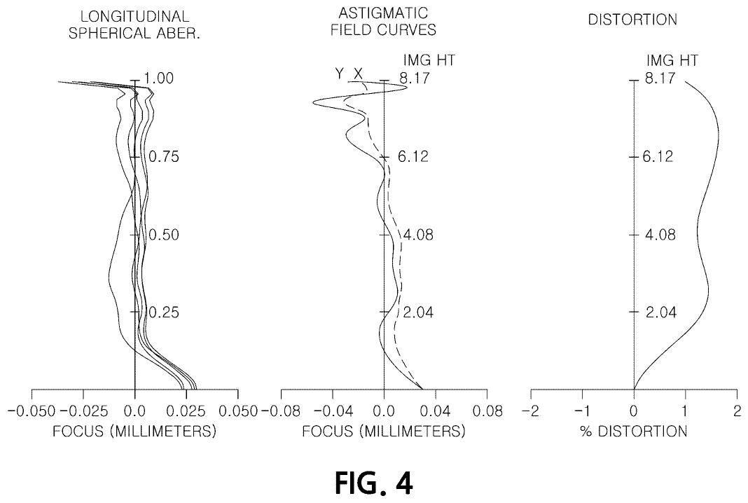

FIG. 3 is a configuration diagram of an optical imaging system according to a second embodiment of the present disclosure, and FIG. 4 is a diagram illustrating aberration characteristics of the optical imaging system illustrated in FIG. 3.

Referring to FIG. 3, an optical imaging system 200 according to a second embodiment of the present disclosure includes a first lens 210, a second lens 220, a third lens 230, a fourth lens 240, a fifth lens 250, a sixth lens 260, a seventh lens 270, and an eighth lens 280 sequentially disposed in ascending numerical order along an optical axis of the optical imaging system 200 from an object side of the first lens 210 toward an imaging plane IP, and may further include a filter IF and an image sensor (not shown).

The optical imaging system 200 may further include a reflective member R disposed in front of the first lens 210. The reflective member R may be a prism, but may also be provided as a mirror.

The optical imaging system 200 may further include a stop ST. The stop ST may be disposed in front of an object-side surface of the first lens 210. For example, the stop ST may be disposed at an end of an effective radius of the object-side surface of the first lens 210.

The optical imaging system 200 according to the second embodiment of the present disclosure may form a focus on the imaging plane IP.

Lens characteristics of each lens (radiuses of curvature, a thickness of the lens or a distance between lenses, a refractive index, and an Abbe number) are illustrated in Table 3 below.

TABLE 3

| Surface | | Radius of | Thickness/ | Refractive | Abbe |
|---|---|---|---|---|---|
| No. | Element | Curvature | Distance | Index | Number |
| S1 | First | 4.675 | 1.798 | 1.497 | 81.6 |
| S2 | Lens | 30.731 | 0.135 | | |
| S3 | Second | 5.061 | 0.609 | 1.639 | 23.5 |
| S4 | Lens | 3.900 | 0.821 | | |
| S5 | Third | 13.069 | 0.495 | 1.544 | 56.1 |
| S6 | Lens | 19.192 | 0.912 | | |
| S7 | Fourth | −31.322 | 0.782 | 1.6867 | 18.4 |
| S8 | Lens | 23.407 | 0.073 | | |
| S9 | Fifth | −68.350 | 1.061 | 1.544 | 56.1 |
| S10 | Lens | −13.456 | 0.457 | | |
| S11 | Sixth | 33.316 | 0.535 | 1.614 | 25.9 |
| S12 | Lens | 9.334 | 0.288 | | |
| S13 | Seventh | 2.763 | 0.774 | 1.568 | 37.4 |
| S14 | Lens | 7.364 | 1.701 | | |
| S15 | Eighth | −74.495 | 0.600 | 1.5348 | 55.7 |
| S16 | Lens | 5.259 | 0.239 | | |
| S17 | Filter | Infinity | 0.210 | 1.517 | 64.2 |
| S18 | | Infinity | 1.440 | | |
| S19 | Imaging | Infinity | | | |
| | Plane | | | | |

In the second embodiment of the present disclosure, the first lens 210 has a positive refractive power, an object-side surface of the first lens 210 is convex in a paraxial region thereof, and an image-side surface of the first lens 210 is concave in a paraxial region thereof.

The second lens 220 has a negative refractive power, an object-side surface of the second lens 220 is convex in a paraxial region thereof, and an image-side surface of the second lens 220 is concave in a paraxial region thereof.

The third lens 230 has a positive refractive power, an object-side surface of the third lens 230 is convex in a paraxial region thereof, and an image-side surface of the third lens 230 is concave in a paraxial region thereof.

The fourth lens 240 has a negative refractive power, and an object-side surface and an image-side surface of the fourth lens 240 are concave in respective paraxial regions thereof.

The fifth lens 250 has a positive refractive power, an object-side surface of the fifth lens 250 is concave in a paraxial region thereof, and an image-side surface of the fifth lens 250 is convex in a paraxial region thereof.

The sixth lens 260 has a negative refractive power, an object-side surface of the sixth lens 260 is convex in a paraxial region thereof, and an image-side surface of the sixth lens 260 is concave in a paraxial region thereof.

The seventh lens 270 has a positive refractive power, an object-side surface of the seventh lens 270 is convex in a paraxial region thereof, and an image-side surface of the seventh lens 270 is concave in a paraxial region thereof.

The eighth lens 280 has a negative refractive power, and an object-side surface and an image-side surface of the eighth lens 280 are concave in respective paraxial regions thereof.

In addition, either one or both of the seventh lens 270 and the eighth lens 280 has at least one inflection point on either one or both of the object-side surface and the image-side surface thereof.

For example, the object-side surface of the seventh lens 270 may be convex in a paraxial region thereof and concave in a portion other than the paraxial region.

Each surface of each of the first lens 210 to the eighth lens 280 has aspherical surface coefficients as illustrated in Table 4 below. For example, the object-side surface and the image-side surface of each of the first lens 210 to the eighth lens 280 are both aspherical.

TABLE 4

| Surface | | | | | | |
|---|---|---|---|---|---|---|
| No. | S1 | S2 | S3 | S4 | S5 | S6 |
| K | −1.130E+00 | 4.675E+01 | −2.494E+00 | −2.047E+00 | −1.247E+01 | −3.646E+01 |
| A | −1.368E−03 | 3.108E−03 | 4.289E−03 | 8.999E−04 | 1.430E−03 | 7.845E−04 |
| B | −2.746E−04 | −2.196E−03 | −1.699E−03 | 1.443E−03 | −1.105E−03 | 3.336E−03 |
| C | 2.606E−04 | 1.141E−03 | 3.634E−04 | −3.504E−03 | 2.064E−03 | −6.957E−03 |
| D | −1.783E−04 | −5.418E−04 | 1.085E−05 | 3.819E−03 | −2.243E−03 | 9.100E−03 |
| E | 8.368E−05 | 2.269E−04 | −4.465E−05 | −2.706E−03 | 1.550E−03 | −7.808E−03 |
| F | −2.763E−05 | −7.557E−05 | 2.007E−05 | 1.326E−03 | −7.053E−04 | 4.605E−03 |
| G | 6.518E−06 | 1.887E−05 | −5.682E−06 | −4.619E−04 | 2.122E−04 | −1.921E−03 |
| H | −1.107E−06 | −3.452E−06 | 1.182E−06 | 1.161E−04 | −4.040E−05 | 5.756E−04 |
| J | 1.355E−07 | 4.574E−07 | −1.863E−07 | −2.111E−05 | 3.998E−06 | −1.243E−04 |
| L | −1.182E−08 | −4.325E−08 | 2.195E−08 | 2.755E−06 | 7.554E−08 | 1.915E−05 |
| M | 7.155E−10 | 2.840E−09 | −1.858E−09 | −2.522E−07 | −7.928E−08 | −2.055E−06 |
| N | −2.855E−11 | −1.229E−10 | 1.062E−10 | 1.545E−08 | 1.052E−08 | 1.457E−07 |
| O | 6.745E−13 | 3.150E−12 | −3.649E−12 | −5.724E−10 | −6.469E−10 | −6.140E−09 |
| P | −7.136E−15 | −3.621E−14 | 5.688E−14 | 9.804E−12 | 1.612E−11 | 1.163E−10 |

| Surface | | | | | | |
|---|---|---|---|---|---|---|
| No. | S7 | S8 | S9 | S10 | S11 | S12 |
| K | 0.000E+00 | −5.214E+00 | 9.900E+01 | −1.999E+01 | 0.000E+00 | −5.207E+01 |
| A | 7.038E−03 | 3.094E−03 | 3.900E−04 | 9.184E−03 | 2.193E−02 | 4.683E−02 |
| B | 1.092E−03 | 1.680E−03 | −2.247E−04 | −6.873E−03 | −1.840E−02 | −2.105E−02 |
| C | −1.087E−03 | −1.254E−03 | 1.922E−04 | 4.388E−03 | 8.637E−03 | 6.785E−03 |
| D | 1.528E−03 | 1.654E−03 | 1.427E−03 | −1.545E−03 | −2.807E−03 | −1.714E−03 |
| E | −1.703E−03 | −1.186E−03 | −1.364E−03 | 3.255E−04 | 6.719E−04 | 3.364E−04 |
| F | 1.302E−03 | 4.955E−04 | 6.027E−04 | −3.230E−05 | −1.201E−04 | −4.952E−05 |
| G | −6.782E−04 | −1.344E−04 | −1.613E−04 | −2.933E−06 | 1.619E−05 | 5.360E−06 |
| H | 2.456E−04 | 2.518E−05 | 2.862E−05 | 1.624E−06 | −1.656E−06 | −4.228E−07 |
| J | −6.263E−05 | −3.369E−06 | −3.487E−06 | −2.888E−07 | 1.288E−07 | 2.412E−08 |
| L | 1.121E−05 | 3.249E−07 | 2.942E−07 | 3.039E−08 | −7.539E−09 | −9.826E−10 |
| M | −1.380E−06 | −2.229E−08 | −1.692E−08 | −2.046E−09 | 3.231E−10 | 2.785E−11 |
| N | 1.112E−07 | 1.037E−09 | 6.342E−10 | 8.661E−11 | −9.572E−12 | −5.224E−13 |
| O | −5.284E−09 | −2.935E−11 | −1.398E−11 | −2.105E−12 | 1.746E−13 | 5.841E−15 |
| P | 1.122E−10 | 3.810E−13 | 1.376E−13 | 2.242E−14 | −1.469E−15 | −2.954E−17 |

| Surface | | | | |
|---|---|---|---|---|
| No. | S13 | S14 | S15 | S16 |
| K | −1.077E+00 | −1.649E+00 | 9.864E+01 | −1.448E+00 |
| A | 1.801E−02 | −2.787E−02 | 2.288E+00 | 2.074E−02 |
| B | −2.963E−03 | 1.064E−02 | −1.971E+00 | −1.953E−03 |
| C | 8.174E−04 | −2.152E−03 | 1.264E+00 | 1.533E−04 |
| D | −1.377E−04 | 3.003E−04 | −4.841E−01 | −1.010E−05 |
| E | 9.647E−06 | −2.806E−05 | 2.220E−01 | 5.318E−07 |
| F | 1.246E−06 | 1.574E−06 | −7.267E−02 | −1.971E−08 |
| G | −3.993E−07 | −2.671E−08 | 2.310E−02 | 2.779E−10 |
| H | 4.909E−08 | −3.478E−09 | −2.335E−02 | 1.708E−11 |
| J | −3.602E−09 | 3.450E−10 | −4.775E−03 | −1.232E−12 |
| L | 1.715E−10 | −1.635E−11 | 1.026E−02 | 3.866E−14 |
| M | −5.364E−12 | 4.722E−13 | −2.784E−03 | −7.093E−16 |
| N | 1.066E−13 | −8.433E−15 | 3.166E−03 | 7.820E−18 |
| O | −1.223E−15 | 8.581E−17 | −4.655E−04 | −4.814E−20 |
| P | 6.178E−18 | −3.811E−19 | −2.511E−03 | 1.276E−22 |

The optical imaging system 200 according to the second embodiment may have aberration characteristics a illustrated in FIG. 4.

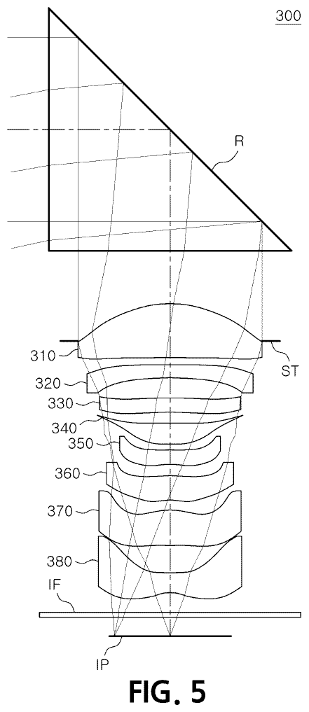

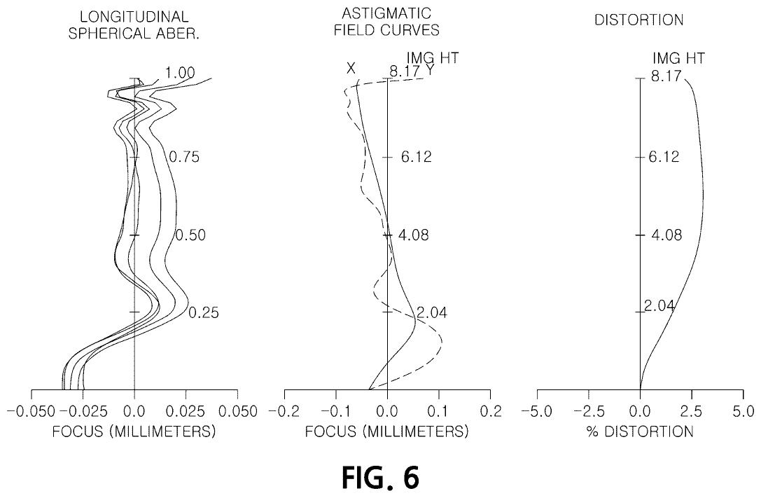

FIG. 5 is a configuration diagram of an optical imaging system according to a third embodiment of the present disclosure, and FIG. 6 is a diagram illustrating aberration characteristics of the optical imaging system illustrated in FIG. 5.

Referring to FIG. 5, an optical imaging system 300 according to a third embodiment of the present disclosure includes a first lens 310, a second lens 320, a third lens 330, a fourth lens 340, a fifth lens 350, a sixth lens 360, a seventh lens 370, and an eighth lens 380 sequentially disposed in ascending numerical order along an optical axis of the optical imaging system 300 from an object side of the first lens 310 toward an imaging plane IP, and may further include a filter IF and an image sensor (not shown).

The optical imaging system 300 may further include a reflective member R disposed in front of the first lens 310. The reflective member R may be a prism, but may also be provided as a mirror.

The optical imaging system 300 may further include a stop ST. The stop ST may be disposed in front of an object-side surface of the first lens 310. For example, the stop ST may be disposed at an end of an effective radius of the object-side surface of the first lens 310.

The optical imaging system 300 according to the third embodiment of the present disclosure may form a focus on the imaging plane IP.

Lens characteristics of each lens (radiuses of curvature, a thickness of a lens or a distance between lenses, a refractive index, and an Abbe number) are illustrated in Table 5 below.

TABLE 5

| Surface | | Radius of | Thickness/ | Refractive | Abbe |
|---|---|---|---|---|---|
| No. | Element | Curvature | Distance | Index | Number |
| S1 | First | 5.000 | 2.216 | 1.544 | 56.1 |
| S2 | Lens | 263.409 | 0.263 | | |
| S3 | Second | 37.199 | 0.561 | 1.6867 | 18.4 |
| S4 | Lens | 9.781 | 0.826 | | |
| S5 | Third | 13.313 | 0.600 | 1.544 | 56.1 |
| S6 | Lens | 15.112 | 0.468 | | |
| S7 | Fourth | −32.382 | 0.859 | 1.544 | 56.1 |
| S8 | Lens | −12.608 | 0.234 | | |
| S9 | Fifth | 40.622 | 0.612 | 1.6867 | 18.4 |
| S10 | Lens | 18.481 | 0.471 | | |
| S11 | Sixth | 24.624 | 1.001 | 1.568 | 37.4 |
| S12 | Lens | 20.925 | 0.404 | | |
| S13 | Seventh | 8.219 | 1.447 | 1.568 | 37.4 |
| S14 | Lens | −111.228 | 1.148 | | |
| S15 | Eighth | −49.387 | 0.830 | 1.5348 | 55.7 |
| S16 | Lens | 4.852 | 0.800 | | |
| S17 | Filter | Infinity | 0.210 | 1.517 | 64.2 |
| S18 | | Infinity | 0.791 | | |
| S19 | Imaging | Infinity | | | |
| | Plane | | | | |

In the third embodiment of the present disclosure, the first lens 310 has a positive refractive power, an object-side surface of the first lens 310 is convex in a paraxial region thereof, and an image-side surface of the first lens 310 is concave in a paraxial region thereof.

The second lens 320 has a negative refractive power, an object-side surface of the second lens 320 is convex in a paraxial region thereof, and an image-side surface of the second lens 320 is concave in a paraxial region thereof.

The third lens 330 has a positive refractive power, an object-side surface of the third lens 330 is convex in a paraxial region thereof, and an image-side surface of the third lens 330 is concave in a paraxial region thereof.

The fourth lens 340 has a positive refractive power, an object-side surface of the fourth lens 340 is concave in a paraxial region thereof, and an image-side surface of the fourth lens 340 is convex in a paraxial region thereof.

The fifth lens 350 has a negative refractive power, an object-side surface of the fifth lens 350 is convex in a paraxial region thereof, and an image-side surface of the fifth lens 350 is concave in a paraxial region thereof.

The sixth lens 360 has a negative refractive power, an object-side surface of the sixth lens 360 is convex in a paraxial region thereof, and an image-side surface of the sixth lens 360 is concave in a paraxial region thereof.

The seventh lens 370 has a positive refractive power, and an object-side surface and an image-side surface of the seventh lens 370 are convex in respective paraxial regions thereof.

The eighth lens 380 has a negative refractive power, and an object-side surface and an image-side surface of the eighth lens 380 are concave in respective paraxial regions thereof.

In addition, either one or both of the seventh lens 370 and the eighth lens 380 has at least one inflection point on either one or both of the object-side surface and the image-side surface thereof.

For example, the object-side surface of the seventh lens 370 may be convex in a paraxial region thereof and concave in a portion other than the paraxial region.

Each surface of each of the first lens 310 to the eighth lens 380 has aspherical surface coefficients as illustrated in Table 6 below. For example, the object-side surface and the image-side surface of each of the first lens 310 to the eighth lens 380 are both aspherical.

TABLE 6

| Surface | | | | | | |
|---|---|---|---|---|---|---|
| No. | S1 | S2 | S3 | S4 | S5 | S6 |
| K | −8.934E−01 | 8.385E+01 | −9.090E+01 | 3.557E+00 | −7.961E+01 | −5.731E+01 |
| A | 1.376E−03 | 5.143E−03 | 8.408E−03 | 2.651E−03 | 1.277E−03 | −7.305E−04 |
| B | −7.126E−04 | −2.341E−03 | −5.971E−03 | −6.596E−04 | −1.798E−03 | −2.455E−03 |
| C | 5.882E−04 | 1.012E−03 | 4.460E−03 | −1.274E−03 | −2.411E−04 | 3.629E−03 |
| D | −2.998E−04 | −4.323E−04 | −2.892E−03 | 1.544E−03 | 9.295E−04 | −4.659E−03 |
| E | 1.032E−04 | 1.482E−04 | 1.369E−03 | −1.020E−03 | −8.455E−04 | 3.652E−03 |
| F | −2.505E−05 | −3.704E−05 | −4.590E−04 | 4.640E−04 | 4.526E−04 | −1.880E−03 |
| G | 4.403E−06 | 6.552E−06 | 1.100E−04 | −1.516E−04 | −1.594E−04 | 6.671E−04 |
| H | −5.678E−07 | −8.076E−07 | −1.903E−05 | 3.592E−05 | 3.861E−05 | −1.671E−04 |
| J | 5.378E−08 | 6.738E−08 | 2.379E−06 | −6.165E−06 | −6.559E−06 | 2.977E−05 |
| L | −3.702E−09 | −3.545E−09 | −2.127E−07 | 7.564E−07 | 7.809E−07 | −3.752E−06 |
| M | 1.804E−10 | 9.386E−11 | 1.326E−08 | −6.456E−08 | −6.390E−08 | 3.267E−07 |
| N | −5.901E−12 | 3.993E−13 | −5.468E−10 | 3.637E−09 | 3.427E−09 | −1.870E−08 |
| O | 1.163E−13 | −9.411E−14 | 1.342E−11 | −1.214E−10 | −1.086E−10 | 6.322E−10 |
| P | −1.046E−15 | 1.776E−15 | −1.481E−13 | 1.819E−12 | 1.545E−12 | −9.570E−12 |

| Surface | | | | | | |
|---|---|---|---|---|---|---|
| No. | S7 | S8 | S9 | S10 | S11 | S12 |
| K | 9.900E+01 | 2.265E+00 | 9.900E+01 | −4.218E+01 | 3.928E+01 | −7.680E+01 |
| A | −2.685E−03 | −2.460E−04 | −1.221E−02 | −1.026E−02 | −8.846E−03 | −5.278E−03 |
| B | 6.863E−03 | −5.319E−03 | 7.303E−03 | 2.058E−03 | 1.404E−03 | −4.241E−03 |
| C | −9.378E−03 | 9.609E−03 | −4.971E−03 | 8.850E−04 | −5.733E−05 | 2.895E−03 |
| D | 7.519E−03 | −9.047E−03 | 2.666E−03 | −1.288E−03 | 1.327E−04 | −1.084E−03 |
| E | −4.019E−03 | 5.243E−03 | −1.238E−03 | 6.658E−04 | −1.502E−04 | 2.816E−04 |
| F | 1.477E−03 | −2.051E−03 | 4.624E−04 | −2.149E−04 | 6.666E−05 | −5.379E−05 |
| G | −3.782E−04 | 5.664E−04 | −1.294E−04 | 4.873E−05 | −1.727E−05 | 7.679E−06 |
| H | 6.769E−05 | −1.126E−04 | 2.641E−05 | −8.057E−06 | 2.955E−06 | −8.182E−07 |
| J | −8.343E−06 | 1.620E−05 | −3.884E−06 | 9.772E−07 | −3.497E−07 | 6.442E−08 |
| L | 6.774E−07 | −1.668E−06 | 4.060E−07 | −8.600E−08 | 2.889E−08 | −3.677E−09 |
| M | −3.229E−08 | 1.199E−07 | −2.932E−08 | 5.341E−09 | −1.640E−09 | 1.473E−10 |
| N | 5.662E−10 | −5.712E−09 | 1.387E−09 | −2.218E−10 | 6.106E−11 | −3.915E−12 |
| O | 1.791E−11 | 1.619E−10 | −3.857E−11 | 5.526E−12 | −1.344E−12 | 6.177E−14 |
| P | −7.592E−13 | −2.068E−12 | 4.768E−13 | −6.239E−14 | 1.328E−14 | −4.370E−16 |

| Surface | | | | |
|---|---|---|---|---|
| No. | S13 | S14 | S15 | S16 |
| K | 1.783E+00 | −9.611E+01 | 5.368E+01 | −7.780E+00 |
| A | 1.124E−03 | 8.806E−03 | −1.221E−02 | −9.807E−03 |
| B | −5.220E−03 | −2.323E−03 | 5.348E−04 | 9.328E−04 |
| C | 2.311E−03 | 3.378E−04 | 4.629E−05 | −5.871E−05 |
| D | −7.553E−04 | −3.637E−05 | −8.265E−06 | 1.316E−07 |
| E | 1.820E−04 | 2.439E−06 | −3.025E−07 | 4.139E−07 |
| F | −3.227E−05 | −1.891E−08 | 2.250E−07 | −4.841E−08 |
| G | 4.195E−06 | −1.571E−08 | −3.014E−08 | 3.273E−09 |
| H | −3.987E−07 | 1.887E−09 | 2.201E−09 | −1.522E−10 |
| J | 2.748E−08 | −1.227E−10 | −1.021E−10 | 5.067E−12 |
| L | −1.353E−09 | 5.143E−12 | 3.150E−12 | −1.207E−13 |
| M | 4.623E−11 | −1.424E−13 | −6.477E−14 | 2.006E−15 |
| N | −1.041E−12 | 2.520E−15 | 8.558E−16 | −2.203E−17 |
| O | 1.388E−14 | −2.588E−17 | −6.588E−18 | 1.432E−19 |
| P | −8.302E−17 | 1.173E−19 | 2.250E−20 | −4.161E−22 |

The optical imaging system 300 according to the third embodiment may have aberration characteristics as illustrated in FIG. 6.

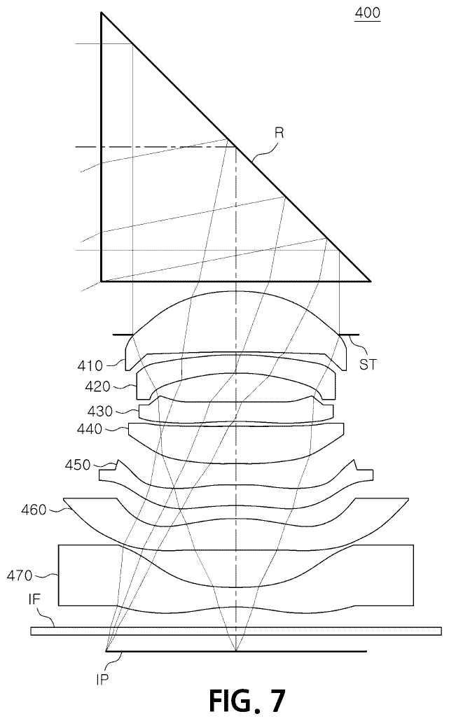

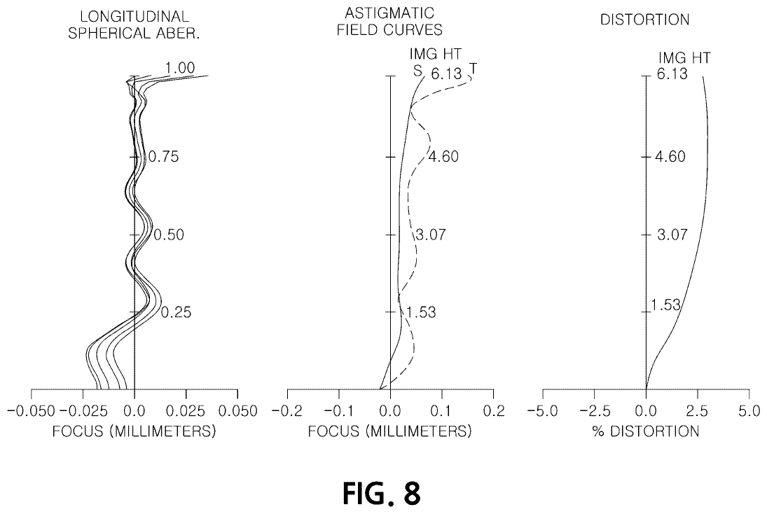

FIG. 7 is a configuration diagram of an optical imaging system according to a fourth embodiment of the present disclosure, and FIG. 8 is a diagram illustrating aberration characteristics of the optical imaging system illustrated in FIG. 7.

An optical imaging system 400 according to a fourth embodiment of the present disclosure includes a first lens 410, a second lens 420, a third lens 430, a fourth lens 440, a fifth lens 450, a sixth lens 460, and a seventh lens 470 sequentially disposed in ascending numerical order along an optical axis of the optical imaging system 400 from an object side of the first lens 410 toward an imaging plane IP, and may further include a filter IF and an image sensor.

The optical imaging system 400 may further include a reflective member R disposed in front of the first lens 410. The reflective member R may be a prism, but may also be provided as a mirror.

The optical imaging system 400 may further include a stop ST. The stop ST may be disposed in front of an object-side surface of the first lens 410. For example, the stop ST may be disposed at an end of an effective radius of the object-side surface of the first lens 410.

The optical imaging system 400 according to the fourth embodiment of the present disclosure may form a focus on the imaging plane IP.

Lens characteristics of each lens (radiuses of curvature, a thickness of a lens or a distance between lenses, a refractive index, and an Abbe number) are illustrated in Table 7 below.

TABLE 7

| Surface | | Radius of | Thickness/ | Refractive | Abbe |
|---|---|---|---|---|---|
| No. | Element | Curvature | Distance | Index | Number |
| S1 | First | 3.826 | 1.728 | 1.544 | 56.1 |
| S2 | Lens | 29.208 | 0.079 | | |
| S3 | Second | 8.080 | 0.508 | 1.6867 | 18.4 |
| S4 | Lens | 4.891 | 0.814 | | |
| S5 | Third | 20.516 | 0.556 | 1.671 | 19.2 |
| S6 | Lens | 10.859 | 0.131 | | |
| S7 | Fourth | 26.026 | 1.072 | 1.544 | 56.1 |
| S8 | Lens | −26.653 | 0.583 | | |
| S9 | Fifth | 6.857 | 0.598 | 1.568 | 37.4 |
| S10 | Lens | 6.324 | 0.350 | | |
| S11 | Sixth | 4.393 | 0.894 | 1.544 | 56.1 |
| S12 | Lens | 247.167 | 1.059 | | |
| S13 | Seventh | −18.567 | 0.550 | 1.5348 | 55.7 |
| S14 | Lens | 3.751 | 0.572 | | |
| S15 | Filter | Infinity | 0.240 | 1.517 | 64.2 |
| S16 | | Infinity | 0.459 | | |
| S17 | Imaging | Infinity | | | |
| | Plane | | | | |

In the fourth embodiment of the present disclosure, the first lens 410 has a positive refractive power, an object-side surface of the first lens 410 is convex in a paraxial region thereof, and an image-side surface of the first lens 410 is concave in a paraxial region thereof.

The second lens 420 has a negative refractive power, an object-side surface of the second lens 420 is convex in a paraxial region thereof, and an image-side surface of the second lens 420 is concave in a paraxial region thereof.

The third lens 430 has a negative refractive power, an object-side surface of the third lens 430 is convex in a paraxial region thereof, and an image-side surface of the third lens 430 is concave in a paraxial region thereof.

The fourth lens 440 has a positive refractive power, and an object-side surface and an image-side surface of the fourth lens 440 are convex in respective paraxial regions thereof.

The fifth lens 450 has a negative refractive power, an object-side surface of the fifth lens 450 is convex in a paraxial region thereof, and an image-side surface of the fifth lens 450 is concave in a paraxial region thereof.

The sixth lens 460 has a positive refractive power, an object-side surface of the sixth lens 460 is convex in a paraxial region thereof, and an image-side surface of the sixth lens 460 is concave in a paraxial region thereof.

The seventh lens 470 has a negative refractive power, and an object-side surface and an image-side surface of the seventh lens 470 are concave in respective paraxial regions thereof.

In addition, either one or both of the sixth lens 460 and the seventh lens 470 has at least one inflection point on either one or both of the object-side surface and the image-side surface thereof.

For example, the object-side surface of the sixth lens 460 may be convex in a paraxial region thereof and concave in a portion other than the paraxial region.

Each surface of the first lens 410 to the seventh lens 470 has aspherical surface coefficients as illustrated in Table 8 below. For example, the object-side surface and the image-side surface of each of the first lens 410 to the seventh lens 470 are both aspherical.

TABLE 8

| Surface No. | S1 | S2 | S3 | S4 | S5 |
|---|---|---|---|---|---|
| K | −1.348E+00 | −3.064E+01 | −1.303E+01 | −3.597E+00 | 6.291E+01 |
| A | 2.988E−03 | −7.914E−03 | −5.953E−03 | −2.185E−03 | −3.130E−03 |
| B | −9.256E−07 | 4.209E−03 | −1.009E−02 | −5.170E−03 | −4.027E−02 |
| C | 5.473E−04 | −2.098E−03 | 2.446E−02 | 1.667E−02 | 1.074E−01 |
| D | −5.757E−04 | 2.324E−03 | −2.819E−02 | −3.335E−02 | −1.776E−01 |
| E | 2.338E−04 | −2.180E−03 | 2.166E−02 | 4.622E−02 | 1.924E−01 |
| F | 7.256E−06 | 1.304E−03 | −1.186E−02 | −4.353E−02 | −1.431E−01 |
| G | −4.886E−05 | −5.242E−04 | 4.738E−03 | 2.823E−02 | 7.521E−02 |
| H | 2.381E−05 | 1.487E−04 | −1.388E−03 | −1.281E−02 | −2.833E−02 |
| J | −6.322E−06 | −3.050E−05 | 2.975E−04 | 4.102E−03 | 7.665E−03 |
| L | 1.066E−06 | 4.525E−06 | −4.595E−05 | −9.226E−04 | −1.475E−03 |
| M | −1.176E−07 | −4.753E−07 | 4.971E−06 | 1.426E−04 | 1.965E−04 |
| N | 8.257E−09 | 3.351E−08 | −3.571E−07 | −1.441E−05 | −1.718E−05 |
| O | −3.361E−10 | −1.421E−09 | 1.528E−08 | 8.570E−07 | 8.837E−07 |
| P | 6.051E−12 | 2.732E−11 | −2.944E−10 | −2.273E−08 | −2.017E−08 |

| Surface No. | S6 | S7 | S8 | S9 | S10 |
|---|---|---|---|---|---|
| K | 8.159E+00 | 3.860E+01 | −4.008E+01 | −5.678E+00 | −6.509E+00 |
| A | −6.504E−03 | −9.062E−03 | −6.902E−03 | −1.655E−02 | −2.309E−02 |
| B | −1.858E−02 | 3.070E−03 | −1.705E−02 | 6.237E−03 | −2.038E−03 |
| C | 3.770E−02 | −4.688E−03 | 3.160E−02 | −5.805E−03 | 5.326E−03 |
| D | −4.603E−02 | 8.408E−03 | −3.454E−02 | 5.437E−03 | −3.179E−03 |
| E | 3.671E−02 | −1.017E−02 | 2.510E−02 | −3.658E−03 | 1.139E−03 |
| F | −2.036E−02 | 7.752E−03 | −1.273E−02 | 1.662E−03 | −2.869E−04 |
| G | 8.125E−03 | −3.908E−03 | 4.628E−03 | −5.236E−04 | 5.351E−05 |
| H | −2.371E−03 | 1.357E−03 | −1.220E−03 | 1.171E−04 | −7.531E−06 |
| J | 5.072E−04 | −3.306E−04 | 2.334E−04 | −1.873E−05 | 8.019E−07 |
| L | −7.880E−05 | 5.643E−05 | −3.206E−05 | 2.133E−06 | −6.373E−08 |
| M | 8.664E−06 | −6.609E−06 | 3.079E−06 | −1.689E−07 | 3.656E−09 |
| N | −6.395E−07 | 5.059E−07 | −1.961E−07 | 8.839E−09 | −1.423E−10 |
| O | 2.844E−08 | −2.279E−08 | 7.433E−09 | −2.749E−10 | 3.339E−12 |
| P | −5.761E−10 | 4.577E−10 | −1.269E−10 | 3.844E−12 | −3.550E−14 |

| Surface No. | S11 | S12 | S13 | S14 |
|---|---|---|---|---|
| K | −2.426E+00 | −9.000E+01 | −3.527E+01 | −7.586E−01 |
| A | −7.671E−03 | 1.397E−02 | −3.966E−02 | −4.342E−02 |
| B | −3.502E−03 | −7.111E−03 | 6.506E−03 | 9.258E−03 |
| C | 9.312E−04 | 1.969E−03 | −9.046E−04 | −1.786E−03 |
| D | 2.388E−04 | −5.126E−04 | 9.626E−05 | 2.814E−04 |
| E | −2.694E−04 | 1.303E−04 | 5.040E−06 | −3.389E−05 |
| F | 1.039E−04 | −2.646E−05 | −3.292E−06 | 3.042E−06 |
| G | −2.453E−05 | 3.839E−06 | 4.954E−07 | −2.033E−07 |
| H | 3.910E−06 | −3.889E−07 | −4.211E−08 | 1.017E−08 |
| J | −4.323E−07 | 2.748E−08 | 2.318E−09 | −3.801E−10 |
| L | 3.316E−08 | −1.348E−09 | −8.604E−11 | 1.047E−11 |
| M | −1.729E−09 | 4.501E−11 | 2.149E−12 | −2.061E−13 |
| N | 5.837E−11 | −9.747E−13 | −3.474E−14 | 2.741E−15 |
| O | −1.149E−12 | 1.234E−14 | 3.291E−16 | −2.199E−17 |
| P | 1.001E−14 | −6.937E−17 | −1.390E−18 | 8.019E−20 |

The optical imaging system 400 according to the fourth embodiment may have aberration characteristics as illustrated in FIG. 8.

Values of various characteristics of the optical imaging systems 100 to 400 according to the first to fourth embodiments of the present disclosure are illustrated in Table 9 below.

TABLE 9

| Characteristic | Embodiment 1 | Embodiment 2 | Embodiment 3 | Embodiment 4 |
|---|---|---|---|---|
| f1 | 9.1613 | 10.8199 | 9.3102 | 7.8775 |
| f2 | −17.2174 | −33.2327 | −19.3031 | −19.1155 |
| f3 | 72.8862 | 72.9813 | 183.3593 | −34.8909 |
| f4 | 35.4149 | −19.2094 | 37.2578 | 24.3012 |
| f5 | −39.5678 | 30.4894 | −49.4660 | −240.3540 |
| f6 | 875.5152 | −21.1378 | −271.0583 | 8.1846 |
| f7 | 20.4798 | 7.3131 | 13.4889 | −5.7657 |
| f8 | −10.0511 | −9.1315 | −8.1897 | — |
| f | 10.76 | 10.55 | 11.177 | 7.94 |
| Fno | 1.47 | 1.47 | 1.48 | 1.37 |
| TTL | 13.085 | 12.930 | 13.742 | 10.194 |
| FOV | 73 | 74.4 | 71 | 73.7 |
| f1/f | 0.8514 | 1.0256 | 0.8330 | 0.9921 |
| v2 | 18.4 | 23.5 | 18.4 | 18.4 |
| TTL/FOV | 0.179 | 0.174 | 0.194 | 0.138 |
| TTL/f | 1.216 | 1.226 | 1.229 | 1.284 |
| (R1 − R2)/(R1 + R2) | −0.929 | −0.736 | −0.963 | −0.768 |
| v1 − v2 | 37.7 | 58.1 | 37.7 | 37.7 |
| \|v1 − (v2 + v3)\| | 18.4 | 2 | 18.4 | 18.5 |
| f2/f | −1.6001 | −3.1500 | −1.7270 | −2.4075 |
| \|f3/f\| | 6.7738 | 6.9177 | 16.4051 | 4.3943 |
| \|f4/f\| | 3.2913 | 1.8208 | 3.3334 | 3.0606 |
| \|f5/f\| | 3.6773 | 2.8900 | 4.4257 | 30.2713 |
| \|f1/f2\| | 0.5321 | 0.3256 | 0.4823 | 0.4121 |
| \|f1/f3] | 0.1257 | 0.1483 | 0.0508 | 0.2258 |
| \|f2/f3\| | 0.2362 | 0.4554 | 0.1053 | 0.5479 |
| f12/f | 1.4526 | 1.3146 | 1.3215 | 1.4183 |
| f123/f | 1.2300 | 1.1465 | 1.2331 | 1.7800 |

As set forth above, according to an embodiment of the present disclosure, an optical imaging system that can capture an image having a high resolution and having a slim size is provided.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a plurality of lenses sequentially disposed along an optical axis of the optical imaging system from an object side of the plurality of lenses toward an imaging plane of the optical imaging system; and
a reflective member disposed in front of the plurality of lenses and comprising a reflective surface,
wherein the plurality of lenses comprises a first lens disposed closest to the reflective member and having a positive refractive power, and a second lens disposed adjacent to the first lens on an image side of the first lens and having a negative refractive power, and
conditional expressions 60°<FOV<90° and 1.3<Fno<1.7 are satisfied, where FOV is a field of view of the optical imaging system, and Fno is an F-number of the optical imaging system.

2. The optical imaging system of claim 1, wherein the plurality of lenses comprises at least two lenses having an Abbe number less than 25 and a negative refractive power.

3. The optical imaging system of claim 1, wherein a conditional expression 1.00<TTL/f<1.29 is satisfied, where TTL is a distance along the optical axis from an object-side surface of the first lens to the imaging plane, and f is a total focal length of the optical imaging system.

4. The optical imaging system of claim 1, wherein conditional expressions 0.5<f1/f <1.5 and −3.5<f2/f<−1 are satisfied, where f1 is a focal length of the first lens, f2 is a focal length of the second lens, and f is a total focal length of the optical imaging system.

5. The optical imaging system of claim 1, wherein a conditional expression 1.2<f12/f<1.6 is satisfied, where f12 is a composite focal length of the first lens and the second lens, and f is a total focal length of the optical imaging system.

6. The optical imaging system of claim 1, wherein a conditional expression 1.0<f123/f<1.9 is satisfied, where f123 is a composite focal length of the first lens, the second lens, and the third lens, and f is a total focal length of the optical imaging system.

7. The optical imaging system of claim 1, wherein a conditional expression 0<|f1/f2|<0.6 is satisfied, where f1 is a focal length of the first lens, and f2 is a focal length of the second lens.

8. The optical imaging system of claim 1, wherein a conditional expression 0.05 mm/°<TTL/FOV<0.2 mm/° is satisfied, where TTL is a distance along the optical axis from an object-side surface of the first lens to the imaging plane.

9. The optical imaging system of claim 1, wherein conditional expressions 15<v2<25 and 30<v1−v2<60 are satisfied, where v1 is an Abbe number of the first lens, and v2 is an Abbe number of the second lens.

10. The optical imaging system of claim 1, wherein the plurality of lenses further comprises a third lens disposed adjacent to the second lens on an image side of the second lens, and
a conditional expression 0<|v1−(v2+v3)|<19 is satisfied, where v1 is an Abbe number of the first lens, v2 is an Abbe number of the second lens, and v3 is an Abbe number of the third lens.

11. The optical imaging system of claim 1, wherein a conditional expression −1.0<(R1−R2)/(R1+R2)<−0.3 is satisfied, where R1 is a radius of curvature of an object-side surface of the first lens, and R2 is a radius of curvature of an image-side surface of the first lens.

12. The optical imaging system of claim 1, wherein the plurality of lenses further comprises a third lens, a fourth lens, a fifth lens, a sixth lens, and a seventh lens, and
the first lens, the second lens, the third lens, the fourth lens, the fifth lens, the sixth lens, and the seventh lens are sequentially disposed in ascending numerical order along the optical axis from an object side of the first lens toward the imaging plane.

13. The optical imaging system of claim 12, wherein the first lens has a positive refractive power, the second lens has a negative refractive power, the third lens has a negative refractive power, the fourth lens has a positive refractive power, the fifth lens has a negative refractive power, the sixth lens has a positive refractive power, and the seventh lens has a negative refractive power.

14. The optical imaging system of claim 12, wherein any one or any combination of any two or more of conditional expressions listed below are satisfied:
$$4 < \vert f 3 / f \vert < 17$$
$$1.5 < \vert f 4 / f \vert < 3.5$$
$$2 < \vert f 5 / f \vert < 31$$
where f3 is a focal length of the third lens, f4 is a focal length of the fourth lens, f5 is a focal length of the fifth lens, and f is a total focal length of the optical imaging system.

15. The optical imaging system of claim 12, wherein a conditional expression 0<|f1/f3|<0.4 is satisfied, where f1 is a focal length of the first lens, and f3 is a focal length of the third lens.

16. The optical imaging system of claim 12, wherein a conditional expression 0< |f2/f3|<0.7 is satisfied, where f2 is a focal length of the second lens, and f3 is a focal length of the third lens.

17. The optical imaging system of claim 1, wherein the plurality of lenses further comprise a third lens, a fourth lens, a fifth lens, a sixth lens, a seventh lens, and an eighth lens, and
the first lens, the second lens, the third lens, the fourth lens, the fifth lens, the sixth lens, the seventh lens, and the eighth lens are sequentially disposed in ascending numerical order along the optical axis from an object side of the first lens toward the imaging plane.

18. The optical imaging system of claim 17, wherein the first lens has a positive refractive power, the second lens has a negative refractive power, the third lens has a positive refractive power, the seventh lens has a positive refractive power, and the eighth lens has a negative refractive power.

19. The optical imaging system of claim 1, further comprising a stop disposed between an object-side surface of the first lens and the reflective member.

20. The optical imaging system of claim 1, wherein a rearmost lens of the plurality of lenses has a major axis and a minor axis perpendicular to each other and intersecting each other and intersecting the optical axis, and
the major axis is longer than the minor axis.
